(19) United States
(12) Patent Application Publication
(10) Pub. No.: US 2025/0098560 A1
(43) Pub. Date: Mar. 27, 2025

(54) SELF-ADJUSTING IMPLEMENT PLATFORM FOR THREE POINT HITCH AND METHOD THEREFORE

(71) Applicant: SAMUEL ALLEN TARVER, JR., Folsom, LA (US)

(72) Inventor: SAMUEL ALLEN TARVER, JR., Folsom, LA (US)

(21) Appl. No.: 18/372,901

(22) Filed: Sep. 26, 2023

(51) Int. Cl. A01B 61/04; A01B 23/04; A01B 63/24

(52) U.S. Cl. CPC A01B 61/044; A01B 23/04; A01B 63/24

(57) ABSTRACT

A three-point hitch drawn platform for an agricultural implement for conditioning soil, crop residue and the like, particularly suitable for use with a disc harrow with at least front and rear disc gangs. A main frame having first and second ends is formed to support said front and rear disc gangs, respectively, so as to facilitate real-time, limited repositioning of the disc gangs relative to first and second stabilizer bars forming part of a subframe which further includes a hitch frame with three-point hitch. The main frame is pivotally connected to the hitch frame at one end, so that other end of said main frame can pivot in response to terrain variations within a predefined distance via first and second stops, each free end of the stabilizer bars engaging the main frame via adjustable helical spring or the like, thereby providing adjustable downward bias transferred to the front and rear disc gangs to accommodate variations terrain during operation, effectively facilitating more consistent tension on the front and rear disc gangs, while providing more enhanced, stable, and consistent terrain penetration during the harrowing process. The present invention further limits or eliminates the issue of alternating right to left thrusting of the discs associated with conventional harrowing implements when three-point hitches are utilized, as well as the associated erratic steering movement on the tractors front steering during same.

### GENERAL DISCUSSION OF THE INVENTION

The present invention relates to agricultural implements for preparation and conditioning of soil, including any crop residue or the like therewith. The device of the present invention is optimized for use with a three-point hitch, with the exemplary embodiment forming an implement platform having an offset rotary disc harrow mounted thereto, although the system could be utilized with various other implements. In the present embodiment, a main frame is provided having first and second ends formed to support the front and rear disc gangs, forming the harrow respectively.

A subframe comprising first and second stabilizer bars, each have a front or first end fixedly engaging a hitch frame with three-point hitch, as well as a second or rear end, which is provided to adjustably limit movement of the main frame.

The main frame pivotally engages said hitch frame of said subframe at its first end, such that the second end of said main frame can adjustably pivot in a generally lateral, limited, vertical up and down orientation relative to said subframe stabilizer bars within a predefined parameter via stops at said second ends of said stabilizer bars, to provide real time, limited repositioning of the disc gangs relative to variations in terrain during the harrowing process, effectively facilitating more consistent tension of the front and rear gangs, while providing a more stable and consistent terrain penetration when compared to conventional systems.

In addition, said main frame (and implement(s) mounted thereto) has applied thereto downward bias provided via spring(s) or the like situated between the relative second ends of said stabilizer bars and said main frame respectively, which downward force is transferred to the first and second disc gangs.

### GENERAL BACKGROUND OF THE INVENTION

Prior to the 1940's, most farm implements, including disc harrows, relied upon a draw bar hitched to the tractor or pulling arrangement, which in effect dragged the implement behind when in use. Harry Ferguson invented the modern three-point hitch, the geometry of which allowed for the transfer of force from the drive wheels of the tractor to the implement, and visa versa, in varying degrees as determined by the operator.

Disc harrows, including those employing front and rear disc gangs and varying configurations and arrangements, have been used for years in order to smooth and level terrain, as well as mix crop residue into the soil, preparing the soil for planting. Harrows can comprise comprises one or more gangs in sequence, each having multiple discs which may have sharpened or scalloped/beveled edges.

In the offset disc harrow arrangement, the discs have all the blades on front section or gang break and till soil/sod in opposite direction orientation of the back section or gang.

Previously, employing a 3-point hitch mounted to a conventional offset harrow was problematic when employed on uneven, rolling ground or the like, as this could cause the conventional harrow to thrust the disc and tractor in one direction by the front section and opposite via the back section due to the rigid connection with the three-point hitch connection, resulting in a failure to properly till the sod and, with a force that could literally thrust the tractor left to right (from the vantage of the operator), making steering control difficult.

In an attempt to compensate for dealing with these conditions, (referring to FIG. 1) the industry provided an elongated hole or slot 2 at the three-point hitch 4 top link to where the tractor's connecting bar attaches to the disc frame, to compensate for the back section 3 of the harrow 1 raising and lowering 8 in response to terrain 5 variations 7. The slot 2 was intended to provide a variable point of engagement, to allow the top link to slide or travel 6 along the slot 2 as required to compensate for said variations 7 in the terrain. This system fails to keep equal pressure on the front and rear disc sections preventing the disc blades from cutting their maximum potential depth and tilling ability while simultaneously allowing/causing the rapidly changing side draft pressure from left to right created by both front and rear section to “oversteer” the front (steering) of the tractor.

Accordingly, this technique is believed ineffective and generally fails to solve the problem, so the issue of instability and inconsistent performance commensurate with operation of three-point hitch mounted offset disc harrows operating in terrain variations remains.

### GENERAL SUMMARY DISCUSSION OF THE INVENTION

The present invention provides a solution to the shortcomings of prior offset rotating harrow designs utilizing three-point hitches or the like on uneven terrain and such. Instead of utilizing the prior art, slotted top-link connection for compensation, described above and deemed ineffective, the present invention includes a novel subframe/main frame configuration as an interface between the tractor and the disc gangs, to compensate for variations in terrain and the tractor during use.

The subframe comprises one or more stabilizer bars fixedly attached to and emanating in one direction from a hitch frame, upon which the three-point hitch points are also provided from the other direction. A main frame pivotally connects to the hitch frame at a one first end, and is positioned to interact with the stabilizer bar(s), so that, in operation and in response to variations in the terrain experienced by the discs, the pivotal movement of the second end of main frame is limited via engagement with the second end of the stabilizer bars.

Further the present invention is configured to provide downward bias at the second end of the main frame via spring(s) situated between the second end of the main frame and stabilizer bar(s), the downward bias enhancing operation to facilitate real time positional adjustment of the harrow disc gangs supported by said main frame during operations, further compensating for said variations in the terrain, while dampening thrusting of said disc gangs while traversing said terrain.

The present invention thereby provides real time positional adjustment of the main frame in relation to the stabilizer bars and hitch of the subframe, effectively dividing the rolling surfaces of the front and rear gangs as they traverse the terrain in use, so as to maintain relatively consistent pressure on both the front and rear discs sections, while eliminating, or at least substantially curtailing, any alternating right to left thrusting of the discs described in the above discussion of issues associated with prior art disc harrow arrangements utilizing three-point hitches, as well as the associated erratic steering movement on the tractors front steering.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1 is a side view of a prior art offset disc harrow comprising front and rear disc gangs mounted to a rigid frame with three-point hitch, with elongated hole 2 or slot at top of hitch for receiving a top link from a tractor.

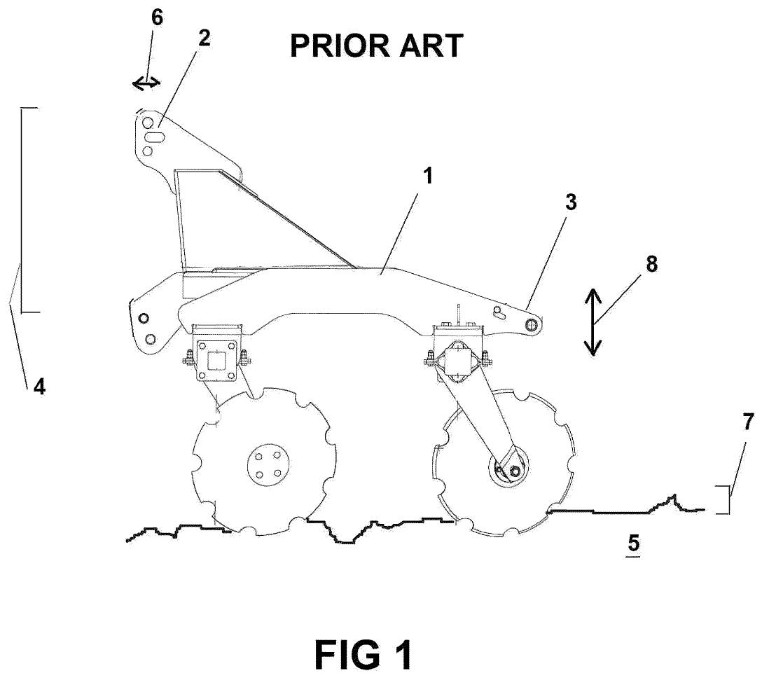

FIG. 2 is a side view of the preferred embodiment of the present invention, illustrating an offset disc harrow for three-point hitch, showing a subframe comprising one of two longitudinally aligned, generally horizontally situated stabilizer bars (partially shown in phantom) emanating from a hitch frame with said three-point hitch, the main frame with disc gangs pivotally engaged to said hitch frame at a first end below said stabilizer bar(s), the main frame engaging said stabilizer bars at their second ends via spring bias as well as enveloping stop members spaced to limit pivotal range of movement of the second end of the main frame in a predetermined, generally vertical range.

FIG. 3 is a side view of the subframe of FIG. 2.

FIG. 4 is a side, perspective view of the subframe of FIG. 3.

FIG. 5 is a side, upper perspective view of the main frame of FIG. 2.

FIG. 6 is an frontal, upper perspective view of the main frame of FIG. 5.

FIG. 7 is a side, perspective view of the invention of the preferred embodiment of the invention of FIG. 2, illustrating the main frame with front and rear disc gangs pivotally engaging 10 the hitch frame of the subframe at the relative front end of said main frame and subframe, with the second relative end of said stabilizer bars of said subframe engaging the second, relative end of said main frame via first and second adjustable extension springs situated therebetween.

FIG. 8 is a frontal, upper perspective view of the invention of FIG. 7, illustrating details as to the three-point hitch, subframe/main frame pivot points at the front, and extension spring interface in the rear.

FIG. 9 is a rear, upper perspective view of the invention of FIG. 8, illustrating details as to the extension spring interface between the second, rear ends of the subframe and main frame, and threaded adjustment mechanisms associated therewith.

FIG. 10 is a side, slightly perspective view of a working prototype of the invention of FIG. 2, illustrating same engaged to a tractor via three-point hitch, further illustrating extension springs used to dampen thrusting of the discs and tractor in operation, the extension springs further applying downward bias to the second end of the main frame, via interconnection with the second end of said stabilizer bars of said subframe.

FIG. 11 is a side, close-up view of the engagement of the offset disc harrow of the invention of FIG. 10 engaged to a tractor via three-point hitch.

FIG. 12 is a top, perspective view the offset disc harrow of the present invention of FIG. 11, shown connected to a tractor via three-point hitch, and illustrating the stabilizer bars and main frame with front and rear disc gangs, with first and second spring dampeners shown providing downward bias to the second end of the main frame via spring engagement to the second end of first and second stabilizer bars, respectively.

FIG. 13 is an upper, perspective, close-up view of the spring engagement to the second end of said stabilizer bar of the invention of FIG. 12.

FIG. 14 is an upper, side, perspective, close-up view of the spring engagement of FIG. 13 further illustrating stops provided on said main frame to limit its pivotal movement via interaction with the stabilizer bars.

### DETAILED DESCRIPTION OF THE INVENTION

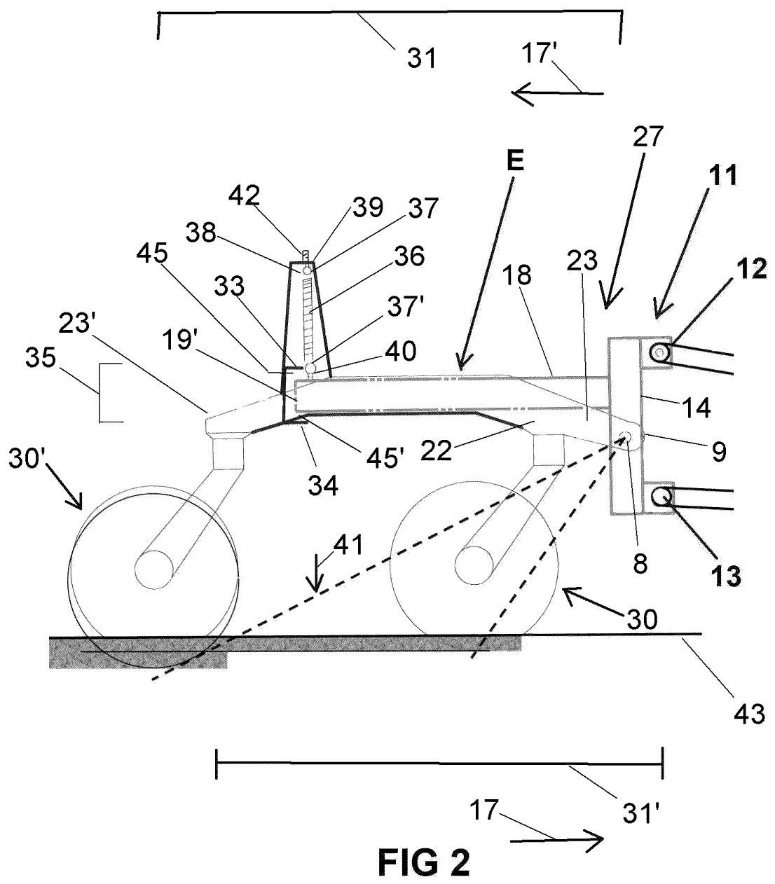

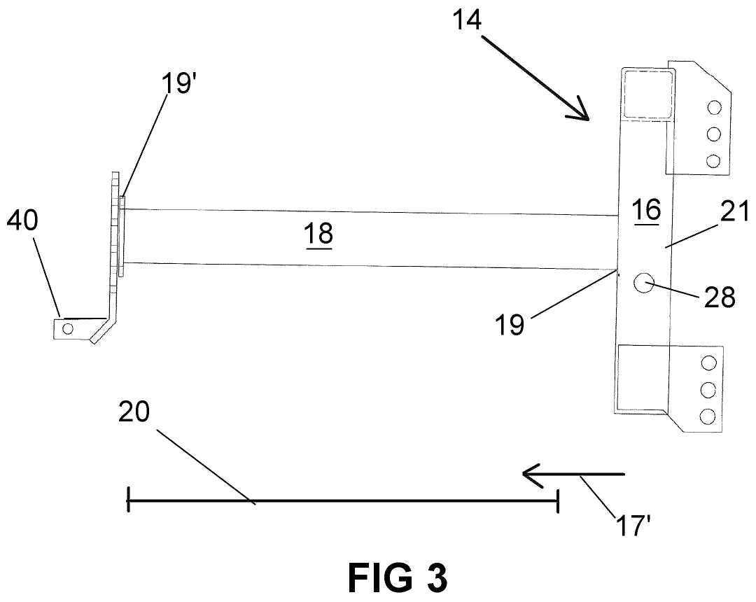

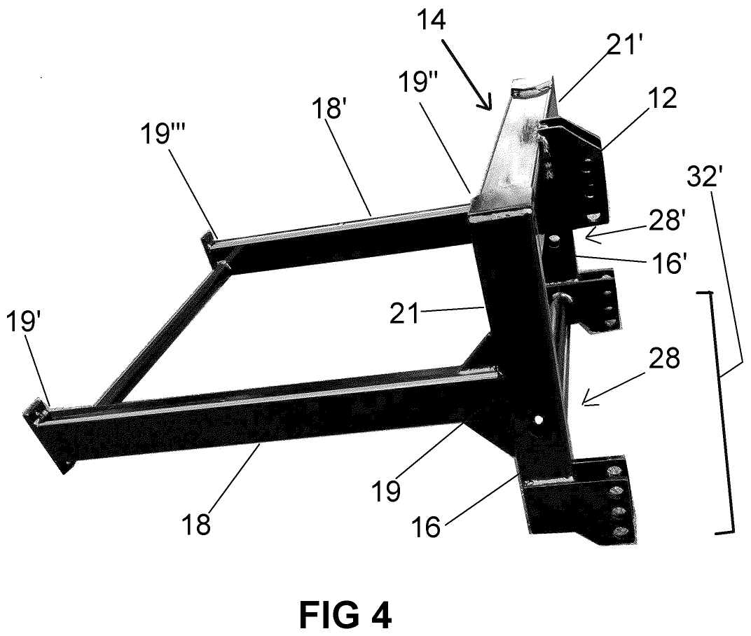

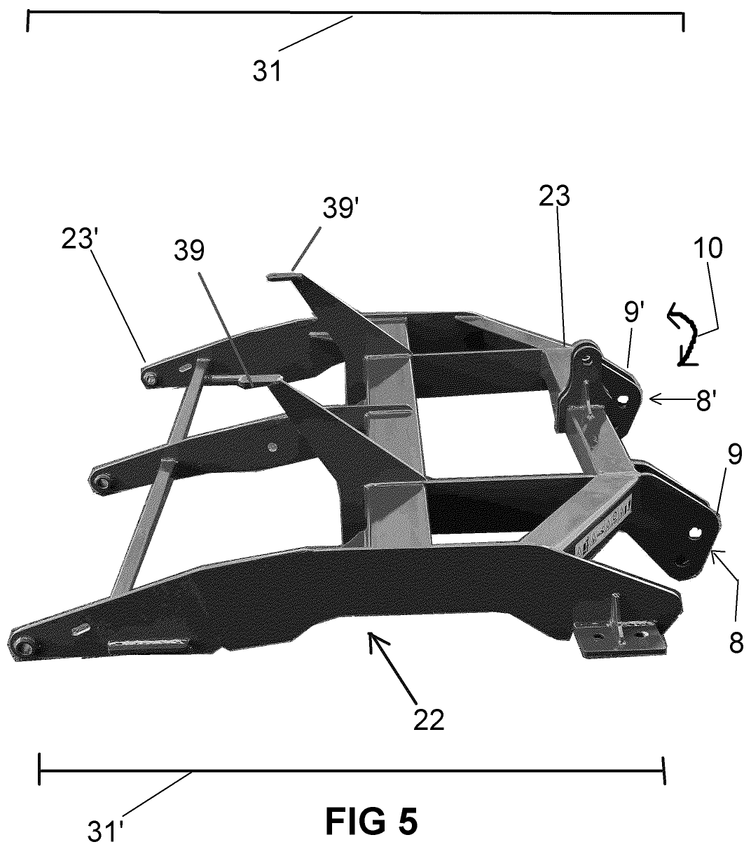

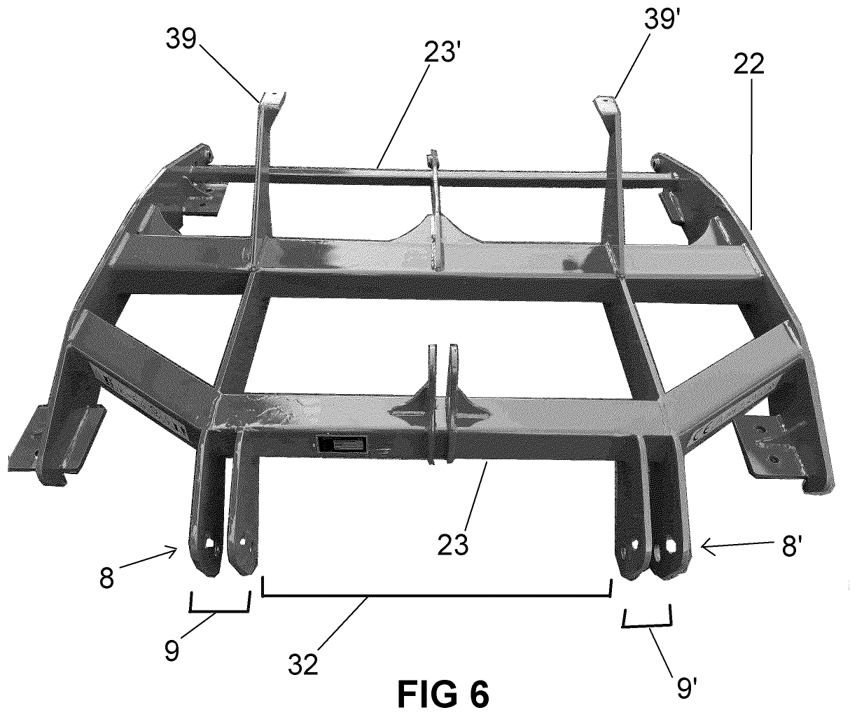

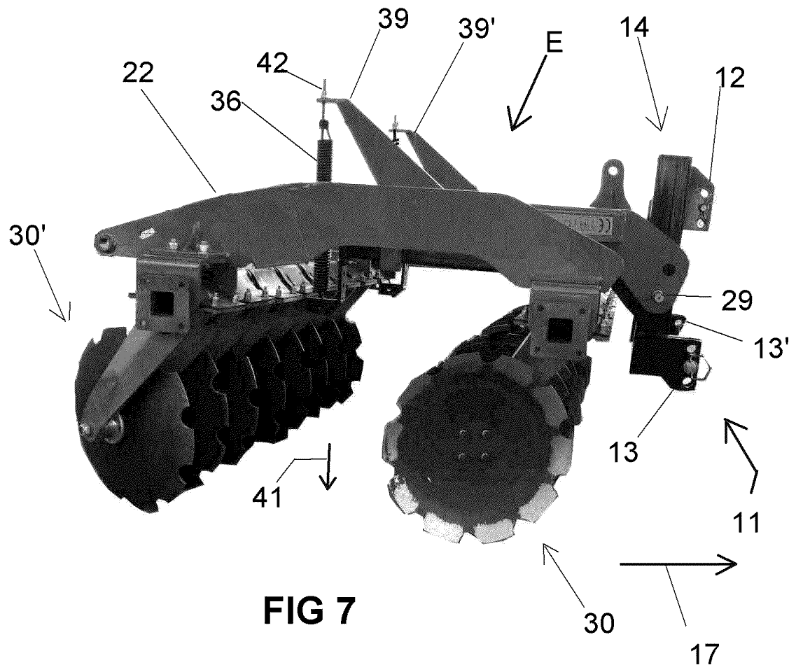

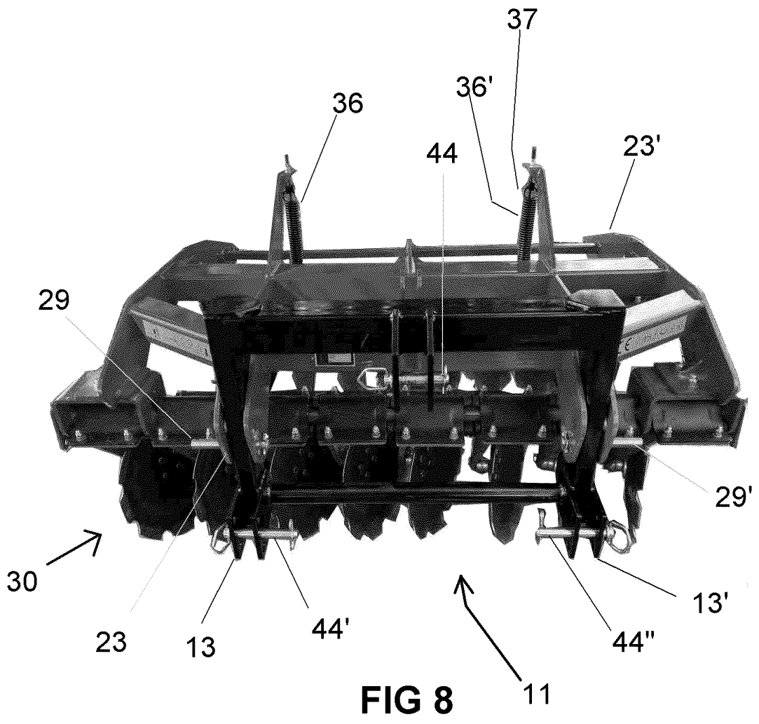

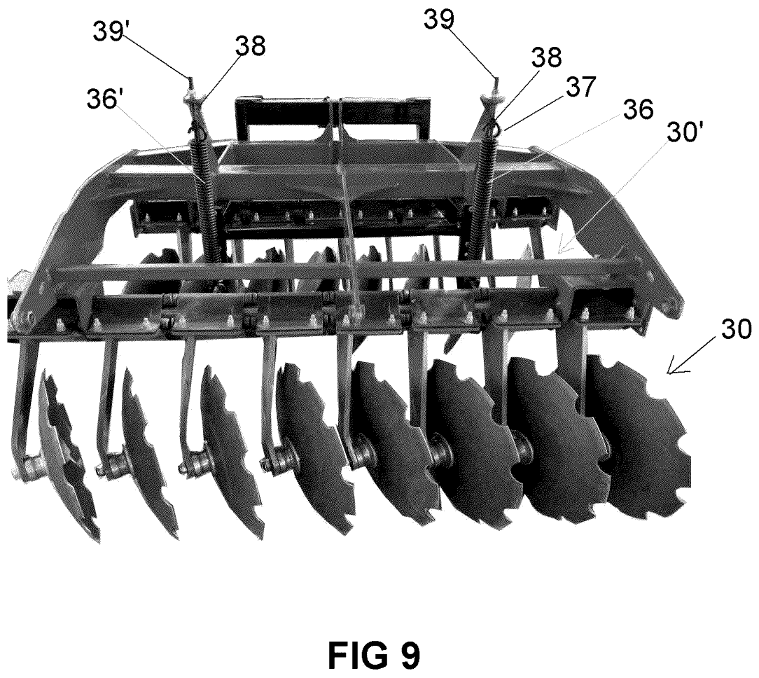

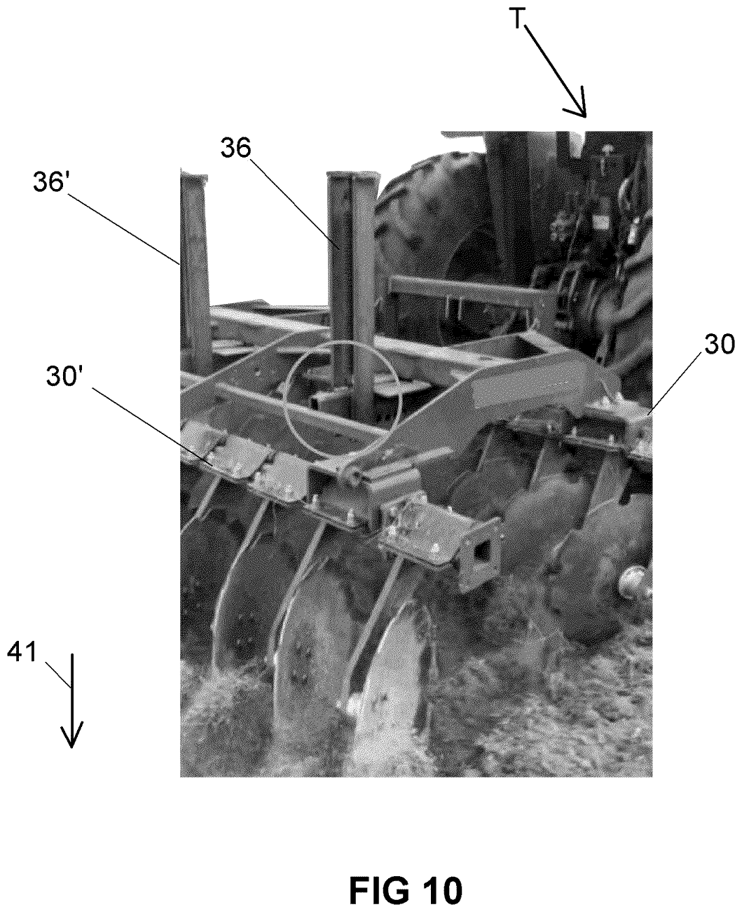

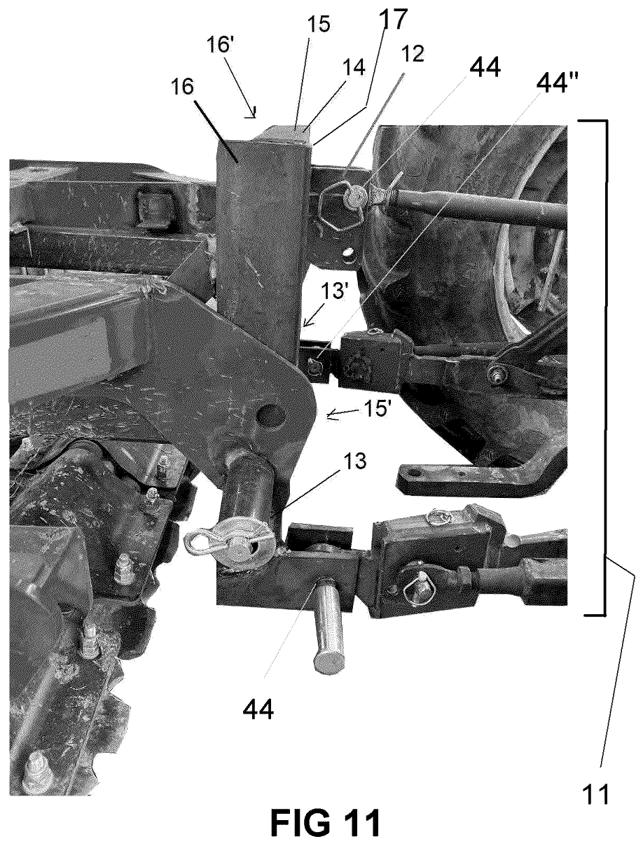

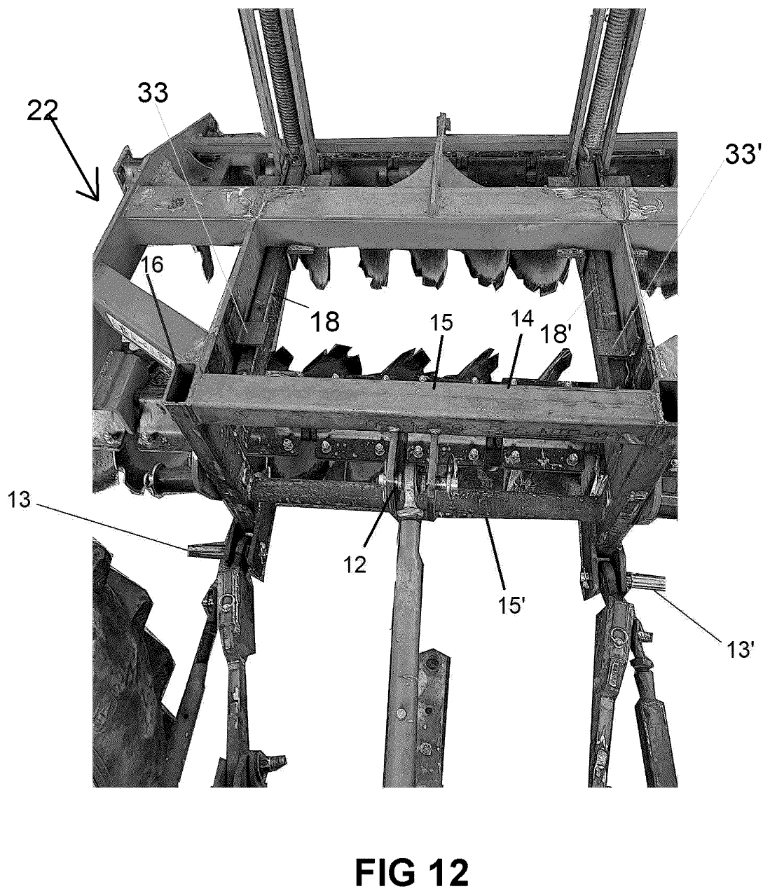

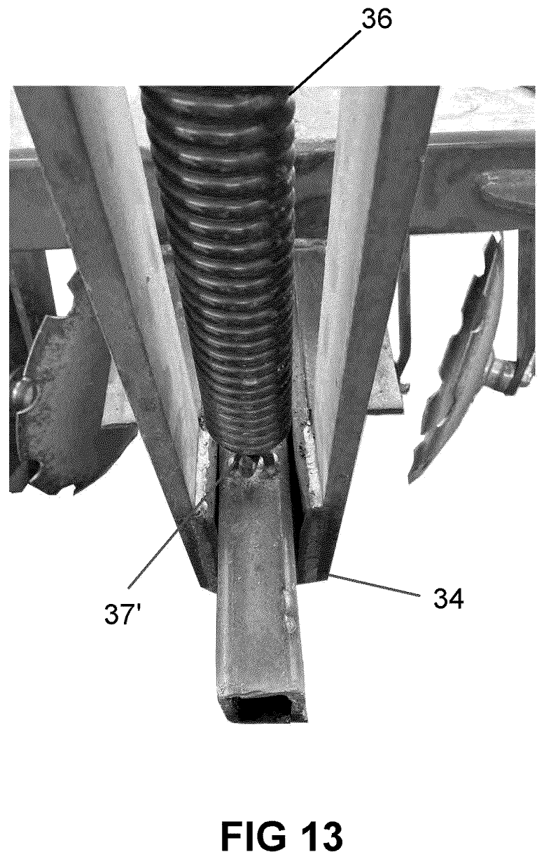

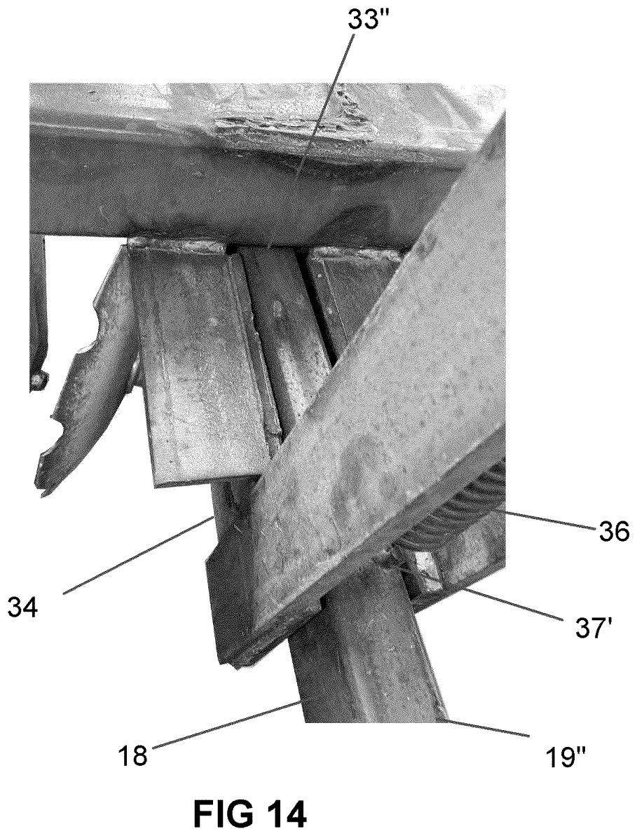

Continuing with FIGS. 2-14, the preferred embodiment E of the present invention provides a platform for mounting an agricultural implement such as, as illustrated in the present case, a disc harrow, comprising a main frame 22 which is pivotally engaged 10 to a subframe 27 comprising forwardly situated, three-point hitch 11 emanating from hitch frame 14, the hitch frame further having mounted thereto rearwardly situated stabilizer bars 18, 18′ formed to operatively interact with the main frame, as will be further described herein.

The main frame 22 is formed to provide a platform for the mounting of various agricultural, construction, or dirt working related implements or the like, and is particularly suitable for disc harrows such as, front 30 and rear 30′ offset rotary disc harrow gangs, although various other alternative implements could be effectively used and operated therewith. In the present example, each disc gang 30, 30′ comprises a plurality of spaced discs being laterally offset in relation to the longitudinal axis 30 of the main frame 22.

The main frame 22 has first frontal 23, and second rear 23′ ends with a length 31 therebetween forming a longitudinal axis 31′, the front 23 end of main frame 22 having emanating therefrom first 9 and second 9′ mounting extensions situated in general longitudinal alignment with the length 31 of the main frame 22, the extensions 9, 9′ being spaced 32 relative to one another to receive the width 32′ of hitch frame 14 therebetween, the extensions 9, 9′ having mounting apertures 8, 8′ formed therethrough, respectively, and are positioned so as to align with receiving apertures 28, 28′ situated through opposing sides 21, 21′ of hitch frame 14, to facilitate pivotal engagement of hitch frame 14 to said extensions 9, 9′ via draw pin 29, 29′, or clevis pen or the like, respectively, situated therethrough, with the hitch frame 14 medially situated and pivotally engaged 10 to the front end 23 of main frame 22.

Hitch frame 14 has provided thereon a three-point hitch 11 forwardly emanating 25 therefrom to provide means of hitching to operating equipment such as a tractor T or the like. The three-point hitch 11 preferably provides a mount forward 17 the hitch frame 14 (as well as the unit itself, when the subframe and main frame are assembled into a working unit), the three-point hitch 11 comprising a single upper link 12 medially situated above first 13 and second 13′ lower links in typical three-point triangular orientation secured via hitch pins 44, 44′, 44″, respectively, the links mounted to project forward 17 of a rectilinear hitch frame 14, the frame comprising upper 15, lower 15′, and first 16 and second 16′ side frame members shown in a box formation and formed of square tubular steel.

Laterally projecting from the rear 17′ of the hitch frame about medially of first 16 and second 16′ side frame members, are first 18 and second 18′ stabilizer bars, each having first 19 and second 19′ ends and a length 20.

The first 18 and second 18′ stabilizer bars are rigidly attached 26 at their first ends 19, 19′, respectively to opposing side frame members 16, 16′ respectively of the hitch frame 14, the stabilizer bars in parallel, longitudinally aligned orientation relative to one another.

The subframe 27 thereby comprises the combination of the hitch frame 14 with three-point hitch 11 at its front, and the stabilizer bars 18, 18′ at the rear.

With the main frame 22 is pivotally engaged 10 to the subframe as shown in the figures and discussed above, the subframe 27 is positioned so that the main frame receives the length of said stabilizer bars 18, 18′, so that upper 33, 33′ and lower 34, 34′ stops formed in the main frame 22 are spaced a predetermined stop spacing 35 (in the present embodiment, about nine inches (9″) apart), to limit movement of the rear or the main frame relative to the second 19′, 19″′ ends of said stabilizer bars 18, 18′, (or visa-versa) in the present exemplary embodiment, to about (for example) plus or minus three inches (3″) (shown as upper space 45 and lower space 45′, respectively) relative to the medial positioning (shown in FIG. 2 wherein there is 3″ spacing 45 above and 3″ spacing 45′ below stabilizer bar) in an upward or downward motion between the stabilizer bar and upper and lower stops, respectively, the stops thereby provided to limit main frame 22 pivotal 10 movement.

It is stressed that the amount of spacing of the stops can vary depending on the configuration of the system and application, so it can be more or less than 3″ in the up and down directions, but this amount of spacing has been found to work well in the present example, wherein the stops 33, 35 are situated at or near the second ends 19′, 19″′ of the stabilizer. In the present, exemplary embodiment of the invention, the stabilizer bars 18, 18′ are about forty-one inches (41″ in length), so that their second ends 19′, 19″′ are about forty-one inches (41″) from the hitch frame 14, with associated pivot mount to the main frame 18.

To reiterate, movement of the rear of the main frame in the present example is thereby limited from a medial position (situated an equal distance between upper 33 and lower 34 stops and longitudinally aligned with the stabilizer bars) to plus or minus three inches (3″) pivotal movement by the stabilizer bars from the medial as permitted via upper 45 or lower 45′ spaces between stabilizer bars and the upper 33 and lower 34 stops, respectively, while the front of the main frame remains pivotally engaged 10 at the hitch frame, as discussed above.

It is emphasized that, although the upper 33 and lower 34 stops are shown at the end of the main frame 27 and stabilizer bars 18, 18′ in the present example, they can be situated elsewhere along the length of the main frame so as to contact the stabilizer bars, including, for example, medially along the length of the stabilizer bars.

Continuing with the Figures, the main frame 22 (and implement(s) mounted thereto, in the present example disc gangs 30, 30′) have applied thereto downward bias 41 provided via helical springs 36, 36′, each having first, upper 37 and second lower 37′ ends, the first 37 ends engaging 38 first 39 and second 39′ upper spring supports associated with main frame 22, said upper springs supports connecting to said springs via threaded connection 42, 42′, respectively to allow the tension of said springs 36, 36′ to be adjustable by selectively shortening or lengthening the threaded connection.

The lower 37′ ends of said springs 36, 36′, engage lower spring supports 40, 40′ associated with the second ends 19′ of stabilizer bars 18, 18′, respectively, thereby placing said springs between the second ends of the stabilizer bars and the main frame 22, so as to provide downward bias to facilitate more consistent penetration of the terrain by the discs 30, 30′, while dampening any thrusting motion imparted on the drive vehicle during operation.

In the preferred embodiment of the present invention with front and rear offset disc gangs having 22-inch blades, the stabilizer bars are shown pivotally engaged 10 to the disc main frame 27½ inches from ground level 43. This becomes the only “fixed” connecting point between the pulling vehicle (in the present example, a tractor) and the main frame with mounted disc gangs. The first 13 and second 13′ lower links of the three-point hitch (which the tractor lift arms are typically connected) connected to the hitch frame 14 is in the present example 19½ inches above ground level 43.

The upper link 12 of the three-point hitch in the present example, is situated about 11 inches above the pivotal connection 10 of the front of main frame 22 with hitch frame 14, although these distances can of course vary during operation.

At the second end of the of the stabilizer bars the springs 36, 36′ are adjusted via threaded connections 42, 42′ so that the second ends 19′ of stabilizer bars 18, 18′ are configured to be situated about midway between the upper 33, 33′ and lower 34, 34′ main frame stops when in use, respectively, so that, in operation, the pivotal connection between main frame and subframe can pivot, with second ends of the stabilizer bars can then shift position up and down up to 6 inches (three inches up, three inches down), in response to said pivot action, while under spring pressure from the stabilizer bars. This is made possible by having the stabilizer bars and disc main frame connected only pivotal connection 10. In the exemplary embodiment of the invention, the springs provided about 300 lbs added ground pressure on the rear disc harrow gang 30′, when weighed on a scale.

Results are the front and rear sections share their total weight in proper amounts determined by adjustable spring tension and provide level, even penetration of the rolling surfaces without left to right forced movement, and at very high speeds. Very desirable tilling is accomplished.

### ELEMENTS OF THE INVENTION

E Preferred embodiment
T Tractor
1 prior art
2 elongated slot
3 top link
4 three-point hitch
5 terrain
6 travel
7 terrain variations
8,′ extension apertures
9,′ main frame extensions
10 pivotal connection
11 three-point hitch
12 upper link
13,′ first, second lower links
14 hitch frame
15,′ upper, lower hitch frame members
16,′ first, second side hitch frame members
17,′ front, rear of subframe
18,′ stabilizer bars
19,′, ″, ″′ first or front, second or rear ends
20 length
21, 21′ opposing sides
22 main frame
23,′ first or front, second or rear ends
24 length
25 forwardly emanating
26 attached
27 subframe
28,′ receiving apertures
29,′ draw pin
30,′ front, rear disc harrow gangs
31,′ main frame length, longitudinal axis
32 spaced mounting extensions, width of hitch frame
33, ′, ″ upper main frame stops
34,′ lower main frame stops
35 stop spacing
36,′ springs
37,′ first upper, second lower ends
38 engaging
39,′ upper spring supports
40,′ lower spring engagement points at second end of stabilizer bars
41 downward bias
42,′ adjustable threaded connections
43 ground level
44, ′, ″ hitch pins
45,′ space between upper stop 33 and stabilizer bar, space between lower stop 34 and stabilizer bar

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

I claim:

1. A self-adjusting implement platform for working ground, comprising:
a subframe comprising:
a hitch frame having a front and rear;
a three-point hitch associated with said front of said hitch frame;
a stabilizer bar having first and second ends and a length, said first end of said stabilizer bar fixedly attached said hitch frame such that said length laterally emanates from said rear of said hitch frame;
a main frame having first and second ends, said first end of said main frame pivotally connected to said hitch frame;
an implement mounted to said main frame, so that said implement contacts the ground and is drawn via said main frame;
a first spring situated between said second end of said stabilizer bar and said main frame, so as to facilitate downward bias on said main frame so as to facilitate downward pressure on said implement mounted to said main frame, urging said implement against the ground;
said first spring further configured so as to provide a dampening effect as to pivotal movement of said main frame, as well as said implement mounted thereto, relative to said subframe, while limiting thrusting of said implement when encountering a variation on said ground during operation.

2. The implement platform of claim 1, wherein said implement comprises an offset rotary disc harrow comprising first and second consecutive disc gangs mounted to said main frame.

3. The implement platform of claim 2, wherein said stabilizer bar comprises a first stabilizer bar, and wherein there is further provided a second stabilizer bar having first and second ends and a length, said first end of said second stabilizer bar fixedly attached to hitch frame such that said length of said second stabilizer bar laterally emanates from said rear of said hitch frame, said second stabilizer bar situated in spaced, parallel alignment with said first stabilizer bar.

4. The implement platform of claim 3, wherein said first spring has first and second ends, said first end attached to said main frame, said second end attached to second end of said first stabilizer bar.

5. The implement platform of claim 4, wherein there is further provided a second spring, said second spring having first and second ends, said first end attached to said main frame, said second end attached to said second end of said second stabilizer bar, said first and second springs configured to facilitate a dampening effect as to pivotal movement of said main frame and implement mounted thereto relative to said subframe, so as to limiting thrusting of said implement when encountering a variation on said ground.

6. The implement platform of claim 5, wherein said first and second springs are adjustable.

7. The implement platform of claim 6, wherein there is further provided upper and lower stops mounted to said mainframe said upper and lower stops formed to selectively engage said stabilizer bars so as to limit pivotal movement of said mainframe relative to said stabilizer bars, to a predefined range of movement.

8. A method of working the ground, comprising the steps of:
a) providing an implement platform comprising a main frame having first and second ends;
b) providing a subframe comprising:
i) a hitch frame having a front and rear;
ii) a three-point hitch associated with said front of said hitch frame;
iii) first and second stabilizer bars having first and second ends, said first ends of said stabilizer bars fixedly attached to and laterally emanating from said rear of said hitch frame;
c) pivotally connecting said first end of said main frame to said hitch frame;
d) mounting an implement to said main frame, so that said implement contacts the ground so as to be drawn via said main frame;
e) mounting a spring between each of said second ends of said stabilizer bars and said main frame, providing mounted springs, while adjusting the tension of said springs to facilitate downward bias on said main frame as well as downward pressure on said implement mounted to said main frame during operation, and urge said implement against the ground;
f) hitching a tractor to said three point hitch and pulling said implement via pivotal connection of said main frame to said hitch frame;
g) utilizing said springs to provide a dampening effect as to pivotal movement of said main frame and said implement relative to said subframe, while limiting thrusting of said implement when encountering a variation on said ground.

9. The method of claim 8, wherein in step “d” said implement comprises an offset rotary disc harrow comprising first and second consecutive disc gangs, and in step “g” there is provided the sub-step “i.” utilizing said springs to provide downward pressure on said first and second disc gangs to enhance tilling of the ground.

10. The method of claim 9, wherein in step “e” there is further provided the step of providing upper and lower stops to said mainframe at a predefined space from said stabilizer bars, and in step “g” utilizing said stops to limit pivotal movement of said mainframe relative to said stabilizer bars to a predefined range of movement.
